(19) United States
(12) Patent Application Publication
(10) Pub. No.: US 2009/0198944 A1
(43) Pub. Date: Aug. 6, 2009

(54) SEMICONDUCTOR MEMORY DEVICE

(75) Inventors: FUJA SHONE, HSINCHU (TW); CHIH NAN YEN, HSINCHU (TW); YUNG LI JI, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: SKYMEDI CORPORATION, HSINCHU (TW)

(21) Appl. No.: 12/026,375

(22) Filed: Feb. 5, 2008

(51) Int. Cl. G06F 12/02

(52) U.S. Cl. 711/171; 711/E12.002

(57) ABSTRACT

An adaptive semiconductor memory device is used for being inserted into a host for storage. The semiconductor memory device comprises a non-volatile memory and a switch. The switch can be a logical switch or a physical switch that controls the semiconductor memory device to be in compliance with either a first specification version or a second specification version of the semiconductor memory device. The second specification version in comparison with the first specification version is used for higher capacity applications.

### BACKGROUND OF THE INVENTION

(A) Field of the Invention

The present invention is related to a semiconductor memory device, which is capable of changing the specification version thereof for providing flexibility in use.

(B) Description of Related Art

There are many kinds of memory cards sharing the same and similar forms; this situation confuses the users. Furthermore, these memory cards may need to use different file systems, increasing the complexity of use.

According to Secure Digital (SD) specifications 1.0, 1.01 and 1.1, although the memory capacity of an SD card cannot exceed 2 gigabytes (GB), the SD card can communicate with a host of SD 1.0, 1.01, 1.1, 2.0 or above. For the capacity, the SD card is operated on a file system FAT (File Allocation Table) 16. In FIG. 1, for example, a 1 GB SD card 11 in compliance with SD specification 1.1 is compatible with an SD 1.1 host system 12 and an SD 2.0, i.e., SDHC (Secure Digital High Capacity), host system 13.

According to SD specification 2.0 or above, i.e., SDHC, the capacity of an SD card can exceed 2 GB. However, this SD card is not compatible with the host of SD 1.0, 1.01 and 1.1, and needs to be operated on the file system FAT 32. In FIG. 2, for example, a 4 GB SD card 14 in compliance with SD specification 2.0 can communicate with the SD 2.0 (SDHC) host 13, but is incompatible with the SD 1.1 host 12.

For an SD card of more than 2 GB, the corresponding host systems, e.g., a digital camera, a mobile phone, or a PDA, have to be in compliance with specification SD 2.0 or above. In other words, the SD card cannot communicate with a host of older specification version such as SD 1.0, 1.01 or 1.1. Therefore, the user may experience incompatibility between a larger capacity memory card of new specification version and older host systems.

### SUMMARY OF THE INVENTION

The present invention provides an adaptive semiconductor memory device, which is capable of changing the specification version thereof so as to provide flexibility in use.

The present invention provides an adaptive semiconductor memory device used for being inserted into a host for storage. The semiconductor memory device comprises a non-volatile memory and a switch. The switch can be a logical switch or a physical switch that controls the semiconductor memory device to be in compliance with either a first specification version or a second specification version of the semiconductor memory device. The second specification version in comparison with the first specification version is used for higher capacity applications.

For example, the memory device is an SD card, the first specification version is SD 1.0, 1.01 or 1.1, and the second specification version is SD 2.0. In an embodiment, the SD card may be provided with a physical switch, and the user can control the switch by hand to configure the SD card to be in compliance with SD 1.0, 1.01 or 1.1 or SD 2.0. Alternatively, the specification version of the SD card may be set by a computer through a card reader or according to the automatic detection of the specification version of the host.

In addition to the change of the specification version, the file system of the semiconductor memory device may be changed accordingly. For example, FAT 16 is used for SD 1.0, 1.01 or 1.1, whereas FAT 32 is used for SD 2.0.

### BRIEF DESCRIPTION OF THE DRAWINGS

FIG. 1 and FIG. 2 illustrate the compatibility problem for a memory device of the new specification version with a host of the old specification version;

FIG. 3 and FIG. 4 illustrate a semiconductor memory device in accordance with a first embodiment of the present invention;

FIG. 5 illustrates a semiconductor memory device in accordance with a second embodiment of the present invention;

FIG. 6 and FIG. 7 illustrate a semiconductor memory device in accordance with a third embodiment of the present invention;

FIG. 8 illustrates a semiconductor memory device in accordance with a fourth embodiment of the present invention; and

FIG. 9 and FIG. 10 illustrate the capacity allocations of the semiconductor memory device for different specification versions in accordance with the present invention.

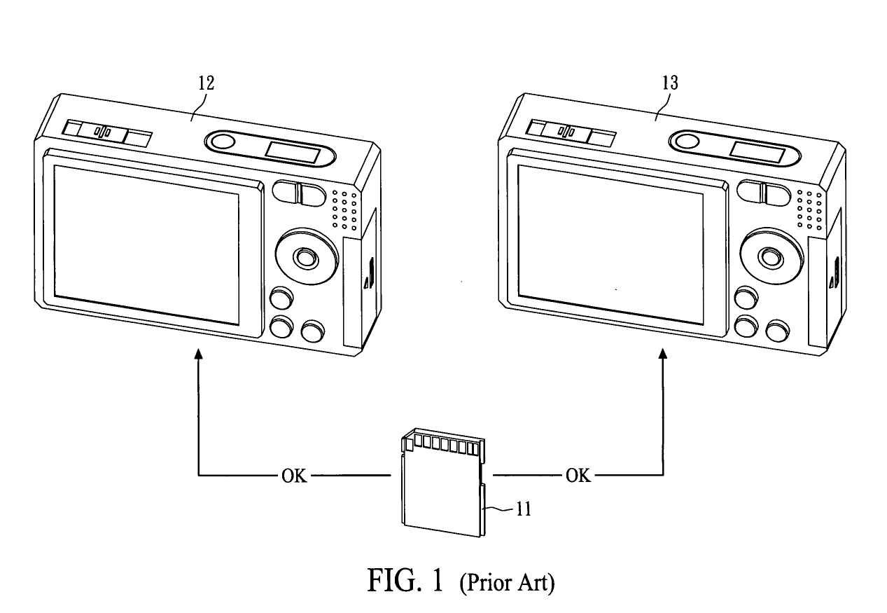

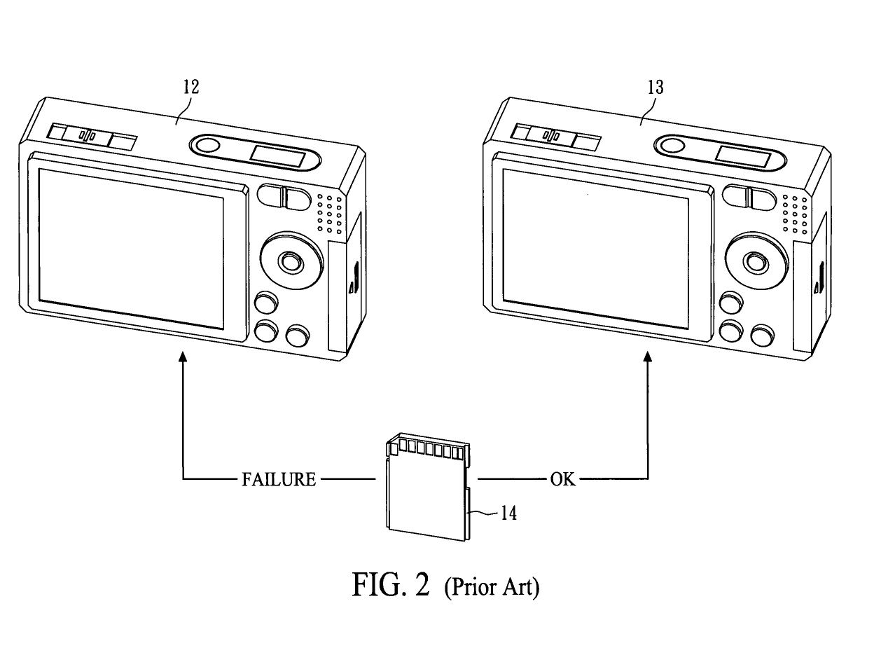

### DETAILED DESCRIPTION OF THE INVENTION

Embodiments of the present invention will now be described with reference to the accompanying drawings.

For an SD card of a capacity larger than 2 GB, because the version SD 1.0, 1.01 and 1.1 do not support SD cards of greater than 2 GB, the SD card has to use SD 2.0, i.e., SDHC, specification as a standard. For instance, if a host (an electronic apparatus), e.g., a digital camera, a mobile phone or a PDA, is in compliance with SD 1.0, 1.01 or 1.1, a traditional SD card of 4 GB cannot be inserted into the host.

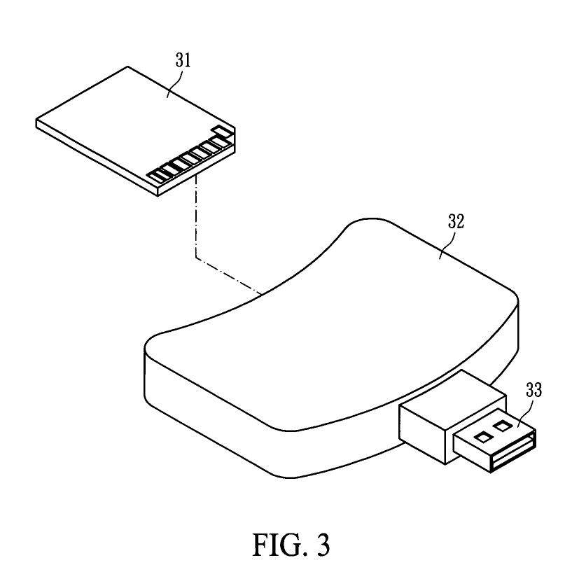

In accordance with an embodiment of the present invention, a card reader is provided to set the SD card to be in compliance with SD 1.0, 1.01 or 1.1 or SD 2.0. As shown in FIG. 3, a card reader 32 is used to receive an adaptive SD card 31 of the present invention. In this embodiment, the card reader 32 is provided with a USB interface 33 for being connected to a computer (not shown). The computer runs an “application (AP)” (a software) to configure the SD card 31 through the card reader 32 and the bus of the SD card 31. In addition, AP also can be stored in the card reader 32, the SD card 31 or the computer.

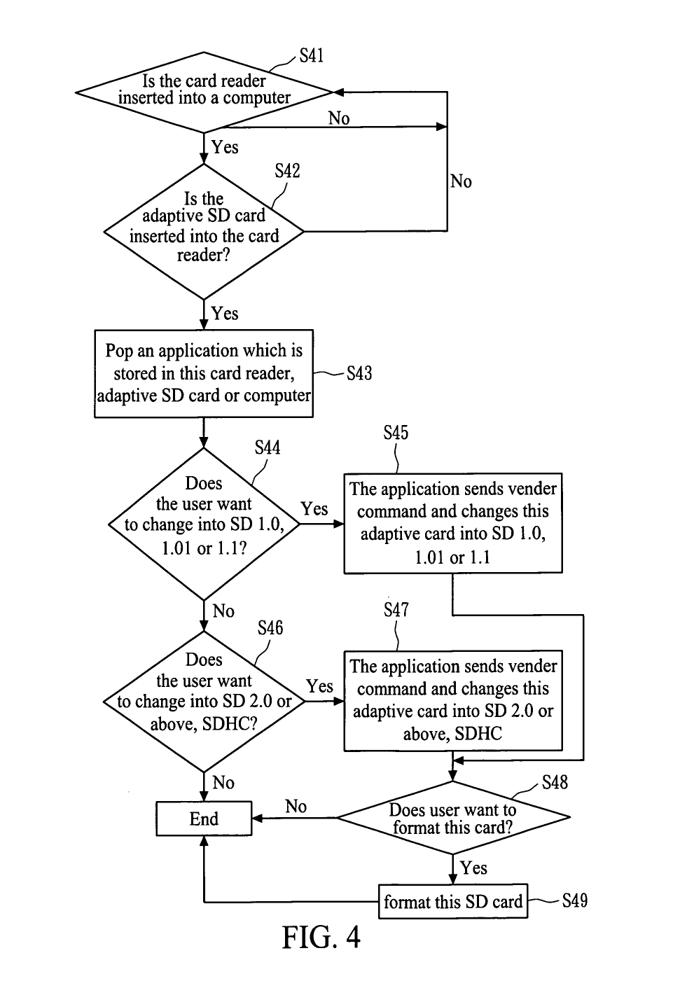

The method to set the specification version of a standard is shown in FIG. 4. In Steps S41 and S42, the user verifies whether the card reader is inserted into the computer and whether the SD card is inserted into the card reader. If the connections between the computer, the card reader and the SD card are ready, an application, e.g., windows AP, stored in the card reader, the adaptive SD card or the computer is popped (Step S43). If the user wants to change the specification to SD 1.0, 1.01 or 1.1 (Step S44), the application sends a command and changes the adaptive SD card into SD 1.0, 1.01 or 1.1 (Step S45). If the user wants to change the specification to SD 2.0 or above, i.e., SDHC (Step S46), the application sends a command and changes the adaptive SD card into SD 2.0 or above, i.e., SDHC (Step S47). In addition to changing the specification version, in some cases the file system of SD card may need to be formatted to comply with the capacity. For example, the SD card of 1 GB uses the file system FAT 16, whereas the SD card of 4 GB uses the file system FAT 32. Therefore, if an SD card of 4 GB needs to be inserted into a host in compliance with SD 1.0, 1.01 or 1.1 (Step S48), the file system is formatted to FAT 16 (Step S49).

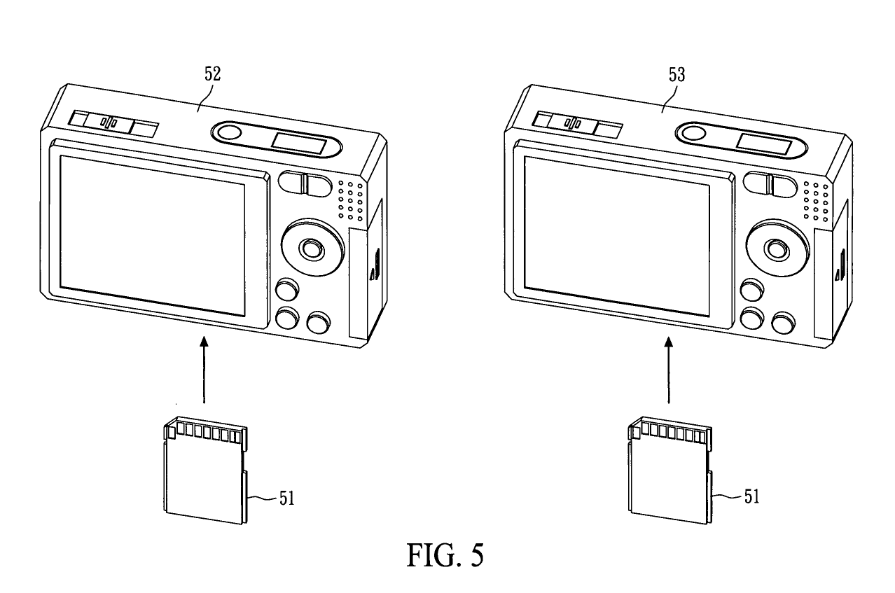

FIG. 5 illustrates a second embodiment of the present invention. After the SD card 51 having an SD interface is inserted into a host 52 or 53, the SD card 51 automatically detects the specification version of the host 52 or 53 and changes the specification version of the SD card accordingly. For example, if the host 52 is in compliance with SD 1.0, 1.01 or 1.1, the SD card 51 will automatically change to be in compliance with SD 1.0, 1.01 or 1.1 specification for a capacity less than 2 GB. Likewise, if the SD card 51 is inserted into the host 53 in compliance with SD 2.0 or above, the SD card 51 will automatically change to be of SD 2.0 or above for a capacity larger than 2 GB, i.e., SDHC. In addition, the adaptive SD card 51 may also be accordingly formatted to FAT 16, FAT 32 or others during its next boot up after the specification version is changed.

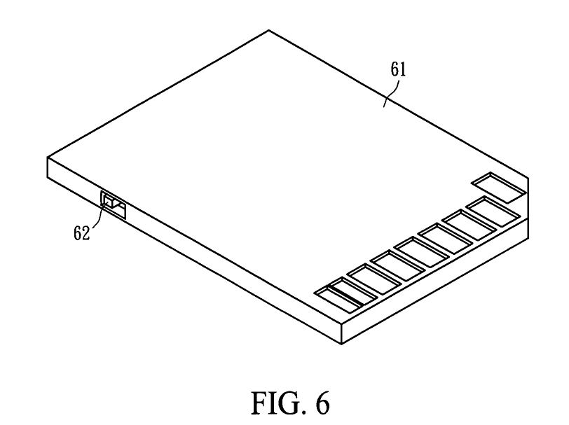

FIG. 6 illustrates a third embodiment of the present invention. An SD card 61 is provided with a physical switch 62 to change the mode of the SD card. For example, the switch 62 can switch between two modes, a capacity mode and a capability mode. If the switch 62 is in the capacity mode, the SD card 61 is in compliance with SD 2.0 or above and is of a capacity greater than 2 GB. If the switch 62 is in the capability mode, the SD card 61 is in compliance with SD 1.0, 1.01 and 1.1 and is of a capacity equal to or less than 2 GB. Accordingly, the mode of the SD card 61 can be changed by the switch 62. Moreover, the SD card 61 can be automatically formatted to FAT 16, FAT 32 or another file system during its next boot up after the SD card 61 has changed the specification version.

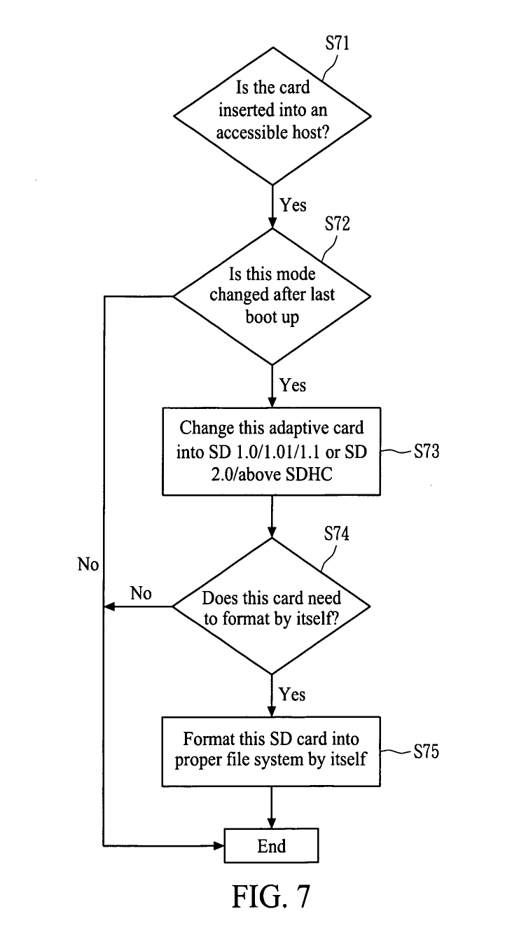

More specifically, the change of specification version by a switch is shown in FIG. 7. First, it is verified whether the SD card is inserted into an accessible host (Step S71). If the SD card is inserted into the host, it is detected whether the mode is changed by the switch (Step S72). If so, the SD card is changed to SD 1.0, 1.01, 1.1 or SD 2.0 (Step S73). If the card requires a change of the file system (Step S74), the SD card is formatted by itself to change the file system accordingly (Step S75).

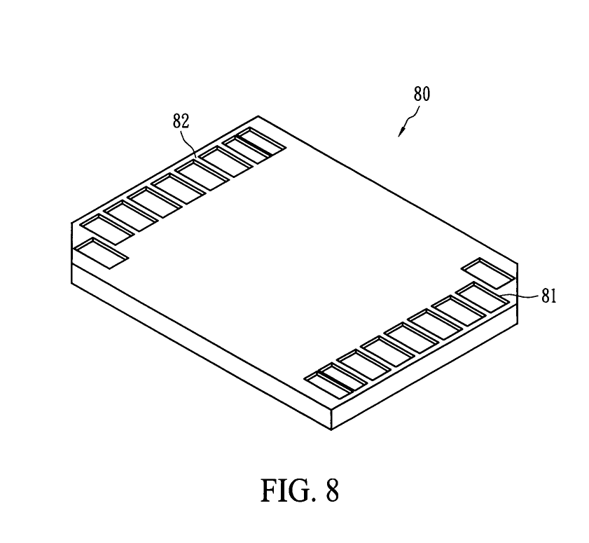

In addition to the above embodiments, the people having ordinary knowledge can implement in other ways. For example, an SD card 80 is provided with two interfaces in which a first interface 81 is in compliance with SD 1.0, 1.01 and 1.1 and a second interface 82 is in compliance with SD 2.0 as shown in FIG. 8. Accordingly, the user can select a proper interface to be inserted into the host.

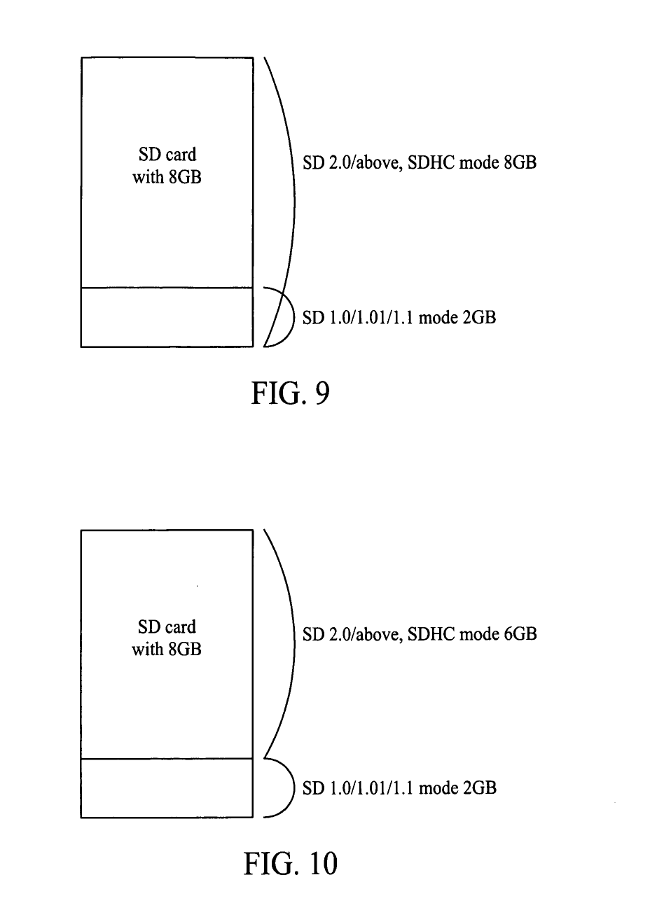

If an SD card has 8 GB, the capacity can be divided in two ways. As shown in FIG. 9, when the SD card is set to SD 1.0, 1.01 or 1.1, the SD card provides 2 GB for storage (2 GB mode). When the SD card is set to SD 2.0 or above, i.e., SDHC, the SD card provides 8 GB for storage (8 GB mode). There is an overlap between SD 1.0/1.01/1.1 and SD 2.0; the data of overlap area may need to be stored by a host first and copied to the SD card after mode change. However, the data of the overlap area may be erased directly if doing so is deemed suitable.

In some cases, the data stored in the SD card need not be erased. As shown in FIG. 10, when the SD card is set to SD 1.0, 1.01 or 1.1, the SD card provides 2 GB of storage (2 GB mode). When the SD card is set to SD 2.0 or above, i.e., SDHC, the SD card provides 6 GB of storage (6 GB mode). There is no overlap between SD 1.0/1.01/1.1 and SD 2.0, therefore it is not necessary to duplicate the data before the mode switch.

The SD card of SD 2.0 specification is incompatible with the old version specification such as SD 1.0, 1.01 or 1.1. Without the present invention, the new SD card of SD 2.0 or above cannot be used for older digital cameras, mobile phones or PDAs. In accordance with the present invention, however, the high capacity SD card of the specification SD 2.0 or above still can communicate with the hosts of SD 1.0, 1.01 and 1.1. In other words, the new SD card with new version of specification can still be used in the electronic apparatuses of old specification, thereby providing superior flexibility in use.

The memory devices are not limited to SD cards, other devices such as CF cards, memory sticks, etc. will be also covered by the scope of the present invention if they substantially implement the present invention.

The above-described embodiments of the present invention are intended to be illustrative only. Numerous alternative embodiments may be devised by those skilled in the art without departing from the scope of the following claims.

What is claimed is:

1. A semiconductor memory device used for being inserted into a host for storage, comprising:
a non-volatile memory; and
a switch controlling the semiconductor memory device to be in compliance with either a first specification version or a second specification version of the semiconductor memory device;
wherein the second specification version in comparison with the first specification version is used for higher capacity applications.

2. The semiconductor memory device of claim 1, wherein the semiconductor memory device is a memory card.

3. The semiconductor memory device of claim 2, wherein the switch is configured by a card reader of the memory card to control the semiconductor memory device to be in compliance with either the first specification version or the second specification version of the semiconductor memory device.

4. The semiconductor memory device of claim 1, wherein the semiconductor memory device is an SD card.

5. The semiconductor memory device of claim 4, wherein the first specification version comprises SD 1.0, SD 1.01 or SD 1.1 and the second specification version comprises SD 2.0.

6. The semiconductor memory device of claim 1, wherein the switch is a physical switch used to set the semiconductor memory device to a first mode in compliance with the first specification version or a second mode in compliance with the second specification version.

7. The semiconductor memory device of claim 6, wherein the physical switch is controlled by a user's hand.

8. The semiconductor memory device of claim 1, wherein the semiconductor memory device automatically detects that the host is in compliance with the first specification or the second specification version, and the switch controls the semiconductor memory device accordingly.

9. The semiconductor memory device of claim 1, further comprising a file system that is set to be in compliance with the first specification version when the semiconductor memory device is in compliance with the first specification version, and is set to be in compliance with the second specification version when the semiconductor memory device is in compliance with the second specification version.

10. The semiconductor memory device of claim 9, wherein the file system is set to FAT 16 and FAT 32 for being in compliance with the first specification version and the second specification version, respectively.

11. The semiconductor memory device of claim 9, wherein the file system is set during the next boot up after the semiconductor memory device is set to be in compliance with either the first specification version or the second specification version.

12. The semiconductor memory device of claim 1, further comprising:
a first interface in compliance with the first specification version; and
a second interface in compliance with the second specification version;
wherein the switch sets the semiconductor memory device to be in compliance with the first specification version when the first interface is inserted into the host, and to be in compliance with the second specification version when the second interface is inserted into the host.

13. The semiconductor memory device of claim 1, wherein the non-volatile memory is set to have a capacity equal to or close to the maximum capacity of the first specification version when the semiconductor memory device is set to be in compliance with the first specification version.

14. The semiconductor memory device of claim 13, wherein the non-volatile memory is set to have a capacity equal to or close to the maximum capacity of the non-volatile memory when the semiconductor memory device is set to be in compliance with the second specification version.

15. The semiconductor memory device of claim 13, wherein the non-volatile memory is set to have a capacity equal to or close to a value found by subtracting the maximum capacity of the first specification version from the maximum capacity of the non-volatile memory when the semiconductor memory device is set to be in compliance with the second specification version.
